(19) United States
(12) Patent Application Publication
(10) Pub. No.: US 2024/0396714 A1
(43) Pub. Date: Nov. 28, 2024

(54) METHODS AND APPARATUS FOR DIGITAL CONTENT VERIFICATION

(71) Applicants: Owen M. Dugan, Sleepy Hollow, NY (US); Dev M. Chheda, Charlotte, NC (US); Gopal K. Goel, Portland, OR (US)

(72) Inventors: Owen M. Dugan, Sleepy Hollow, NY (US); Dev M. Chheda, Charlotte, NC (US); Gopal K. Goel, Portland, OR (US)

(21) Appl. No.: 18/613,099

(22) Filed: Mar. 21, 2024

Related U.S. Application Data
(60) Provisional application No. 63/491,532, filed on Mar. 21, 2023.

(51) Int. Cl. H04L 9/08; H04L 9/32

(52) U.S. Cl. CPC H04L 9/0825; H04L 9/3247

(57) ABSTRACT

In some embodiments, a method of verifying images includes receiving, at a server, a request from a mobile device to sign a device public key of the mobile device; in response to the request from the mobile device, signing, at the server, the device public key with a server private key so as to generate a signed device public key and returning the signed device public key to the mobile device; generating, at the mobile device, data for verification; signing, at the mobile device, the data with a device private key of the mobile device; and storing, at the mobile device, the signed data, the device public key of the mobile device, and the signed device public key of the mobile device as a data token. Numerous other aspects are provided.

### CROSS-REFERENCE TO RELATED APPLICATION

This patent application claims priority to U.S. Provisional Patent Application No. 63/491,532 filed on Mar. 21, 2023, and entitled “Method and Apparatus for Digital Content Verification,” which is hereby incorporated by reference herein in its entirety for all purposes.

### FIELD

The present application relates to validating content on a mobile device, and more particularly to methods and apparatus for digital content verification.

### BACKGROUND

The evolution of digital content generation and dissemination has presented unique challenges in ensuring its authenticity and integrity. In an era where digital manipulation tools are both sophisticated and accessible, the ability to verifiably ascertain the origin and authenticity of digital content, such as images, videos, or audio, has become a paramount concern. This concern extends across various domains, including digital media, journalism, legal evidence, and intellectual property rights, highlighting the necessity for a robust solution to authenticate digital content.

Additionally, the proliferation of advanced editing software has made it increasingly difficult to distinguish between original and altered content, undermining digital media's credibility.

Therefore, there is a need for improved methods and apparatus digital content verification.

### SUMMARY

In some embodiments, a system for verifying images includes a server having a server processor and a server memory, the server processor coupled to the server memory and a mobile device having a device processor and a device memory, the device processor coupled to the device memory. The server includes computer program instructions that, when executed by the server processor, cause the server processor to: receive a request from the mobile device to sign a device public key of the mobile device; and in response to the request from the mobile device, sign the device public key with a server private key of the server and return the signed device public key to the mobile device. The mobile device includes computer program instructions that, when executed by the device processor, cause the device processor to: generate data for verification; sign the data with a device private key of the mobile device; and store the signed data, the device public key of the mobile device, and the signed device public key of the mobile device as a data token within the device memory.

In some embodiments, a method of verifying images includes receiving, at a server, a request from a mobile device to sign a device public key of the mobile device; in response to the request from the mobile device, signing, at the server, the device public key with a server private key so as to generate a signed device public key and returning the signed device public key to the mobile device; generating, at the mobile device, data for verification; signing, at the mobile device, the data with a device private key of the mobile device; and storing, at the mobile device, the signed data, the device public key of the mobile device, and the signed device public key of the mobile device as a data token.

In some embodiments, a system for verifying images includes a server having a server processor and a server memory, the server processor coupled to the server memory and an application executable on a mobile device having a device processor and a device memory. The server includes computer program instructions that, when executed by the server processor, cause the server processor to: receive a request from the mobile device to sign a device public key of the mobile device; and in response to the request from the mobile device, sign the device public key with a server private key of the server and return the signed device public key to the mobile device. The application executable on the mobile device includes computer program instructions that, when executed by the device processor, cause the device processor to: generate data for verification; sign the data with a device private key of the mobile device; and store the signed data, the device public key of the mobile device, and the signed device public key of the mobile device as a data token within the device memory.

Other features and aspects of the present invention will become more fully apparent from the following detailed description, the appended claims, and the accompanying drawings.

### BRIEF DESCRIPTION OF THE DRAWINGS

FIG. 1A illustrates an example system for verifying digital content in accordance with embodiments provided herein.

FIG. 1B illustrates an example embodiment of the system of FIG. 1A for verifying digital content, in accordance with embodiments provided herein, in which attestation information may be employed.

FIG. 2 is a flowchart of an example method of verifying digital content in accordance with one or more embodiments provided herein.

### DETAILED DESCRIPTION

Embodiments provided herein provide systems and methods for verifying digital content. In some embodiments, this may include verifying that digital content was generated on an instance of a specific application (hereinafter “app”) running on a mobile device.

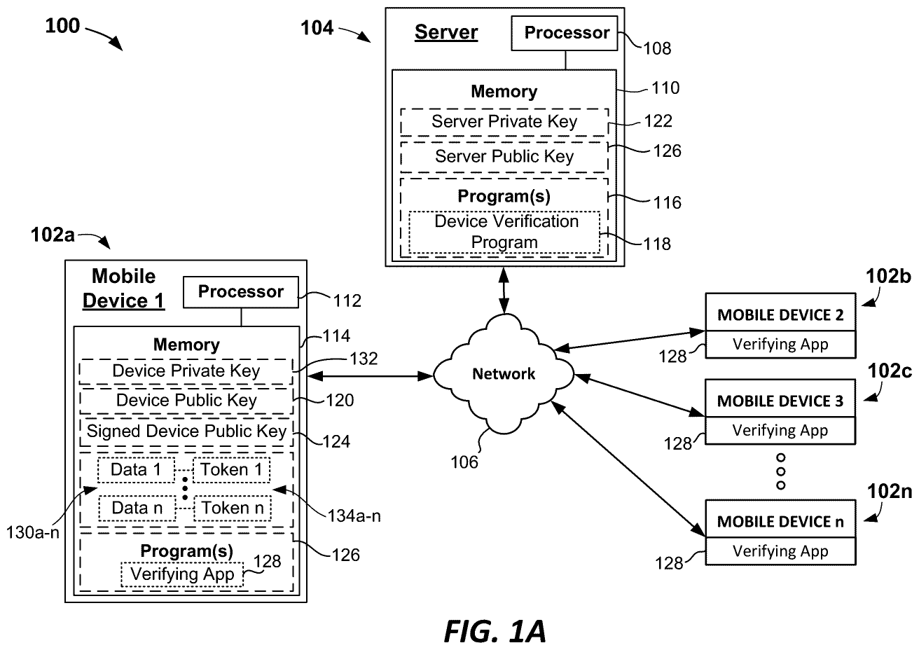

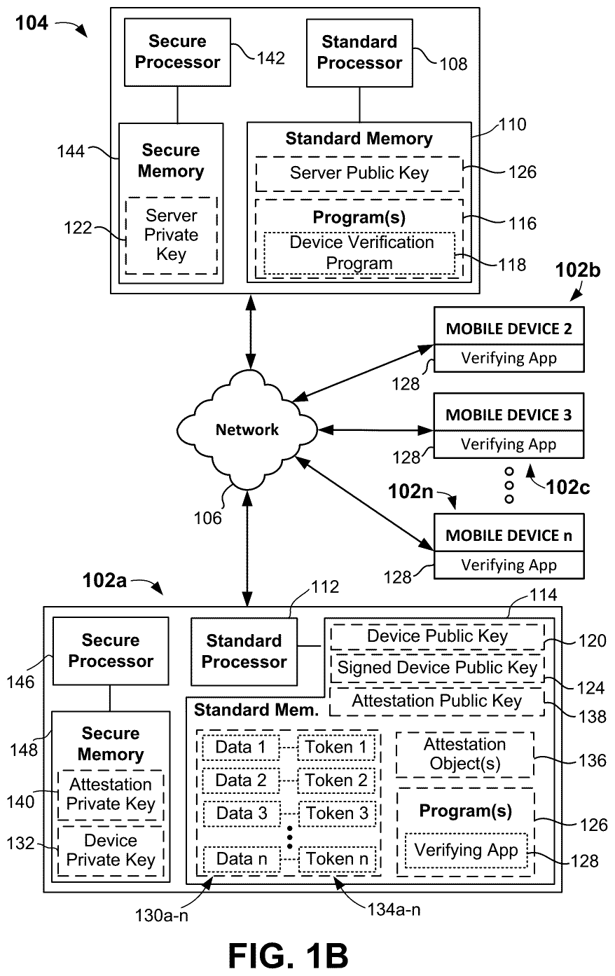

FIG. 1A illustrates an example system 100 for verifying digital content in accordance with embodiments provided herein. With reference to FIG. 1A, system 100 may include a plurality of mobile devices 102a-n that may communicate with a server 104 over a network 106 (e.g., an intranet, the internet, a cellular network, or another communications network). In general, one or more mobile devices may communicate with server 104.

Server 104 may include a server processor 108 coupled to a server memory 110. Mobile device 102a may include device processor 112 coupled to a device memory 114. In some embodiments, mobile devices 102b-n may be similarly configured.

Server 104 may include computer program instructions (e.g., one or more program(s) 116 and/or a device verification program 118) that, when executed by server processor 108, cause server processor 108 to (1) receive a request from mobile device 102a to sign a device public key 120 of mobile device 102a; and (2) in response to the request from mobile device 102a, sign device public key 120 with a server private key 122 of server 104 (e.g., generating a signed device public key 124) and return signed device public key to mobile device 102a. In some embodiments, server 104 may perform similar functions with mobile devices 102b-n.

Mobile device 102a may include computer program instructions (e.g., one or more program(s) 126 and/or a verifying application 128) that, when executed by device processor 112, cause device processor 112 to (1) generate data for verification (e.g., one or more data 130a-n); (2) sign the data with a device private key 132 of mobile device 102a; and store the signed data, device public key 120 of mobile device 102a, and signed device public key 124 of mobile device 102a as one or more data tokens (e.g., one or more data tokens 134a-n) within device memory 114. In some embodiments, mobile devices 102b-n may be similarly configured. For example, in one or more embodiments, verifying application 128 (and/or other computer executable instructions) may be downloadable and executable on mobile devices 102a-n.

Device memory 114 may also include computer program instructions (e.g., one or more program(s) 126 and/or a verifying application 128) that, when executed by the device processor 112, cause device processor 112 to (1) create device private key 132 and device public key 120; send a request to server 104 with device public key 120; and (3) receive signed device public key 124 from server 104. In some embodiments, mobile devices 102b-n may be similarly configured.

Device memory 114 may also include computer program instructions (e.g., one or more program(s) 126 and/or a verifying application 128) that, when executed by device processor 112, cause device processor 112 to provide attestation information to server 104 to verify computer program instructions of mobile device 102a. For example, FIG. 1B illustrates an example embodiment of system 100 for verifying digital content, in accordance with embodiments provided herein, in which attestation information may be employed. In some embodiments, mobile devices 102b-n may be similarly configured.

With reference to FIG. 1B, in some embodiments, server memory 110 may include computer program instructions (e.g., one or more program(s) 116 and/or a device verification program 118) that, when executed by server processor 108, cause server processor 108 to (1) receive attestation information (e.g., one or more attestation object(s) 136 and/or an attestation public key 138) from mobile device 102a; (2) determine if computer instructions of mobile device 102a (e.g., one or more program(s) 126 and/or a verifying application 128) are valid based on the attestation information; (3) sign device public key 120 and return signed device public key 124 to mobile device 102a if server 104 determines the computer instructions of mobile device 102a are valid based on the attestation information; and (3) not sign device public key 120 if server 104 determines the computer instructions of mobile device 102a are invalid based on the attestation information. For example, in some embodiments, attestation information sent to server 104 may include one or more attestation object(s) 136 and/or an attestation public key 138 (e.g., generated from an attestation private key 140 in one or more embodiments). Example attestation objects may include signatures of challenges (e.g., from server 104) by keys stored in secure hardware.

In some embodiments, server 104 may include both a standard processor (e.g., processor 108) and a secure processor 142 and the server memory may include both standard memory (e.g., memory 110) and secure memory 144 as shown in FIG. 1B. For example, in some embodiments, standard memory 110 may include memory that is accessible by any programs on server 104 while secure memory 144 may include memory that may only be accessed by secure processor 142 for signing data or computing public keys. Similarly, in some embodiments, mobile device 102a may include both a standard processor (e.g., processor 112) and a secure processor 146 and the mobile device memory may include both standard memory (e.g., memory 114) and secure memory 148 as shown in FIG. 1B.

In the embodiment of FIG. 1B, server private key 122 may be stored in secure memory 144 of the server 104 and device private key 132 and/or attestation private key 140 may be stored in secure memory 148 of mobile device 102a.

In some embodiments, data generated by mobile device 102a (and/or mobile devices 102b-n) may include images, video, audio, text, and/or any other digital content. In some embodiments, the data may include user content, a hash of user content, or a combination of user content and a hash of user content.

In one or more embodiments, mobile device 102a may be configured to share verified data (e.g., data and a token corresponding to the data) with another mobile device (e.g., mobile device 102b-n) without communicating with server 104. For example, device memory 114 may include computer program instructions (e.g., one or more program(s) 126 and/or a verifying application 128) that, when executed by device processor 112, cause device processor 112 to share data and its corresponding data token (e.g., one or more of data 130a-n and tokens 134a-n) with another mobile device (e.g., 102b-n) without communicating with server 104. In some embodiments, mobile devices may share verified content over network 106, for example. In some embodiments, mobile devices 102b-n may be similarly configured.

In some embodiments, processor 108, 112, 142, and/or 146 may be a computational resource such as, but not limited to, a microprocessor, a microcontroller, an embedded microcontroller, a digital signal processor (DSP), a field programmable gate array (FPGA) configured to perform as a microcontroller, or the like. Memory 110, 114, 144, and/or 148 may be any suitable type of memory, such as, but not limited to, one or more of a volatile memory and/or a non-volatile memory. In one or more embodiments, memory 110, 114, 144, and/or 148 may be a non-transitory memory (e.g., a hard drive, a solid-state drive, a flash-drive, etc.). Memory 110, 114, 144, and/or 148 may have a plurality of instructions stored therein that, when executed by processor 108, 112, 142, and/or 146, cause processor 108, 112, 142, and/or 146 to perform various actions specified by one or more of the stored instructions. Memory 110, 114, 144, and/or 148 may include multiple memory units and/or types of memory. Additionally, in some embodiments, multiple processors may be employed.

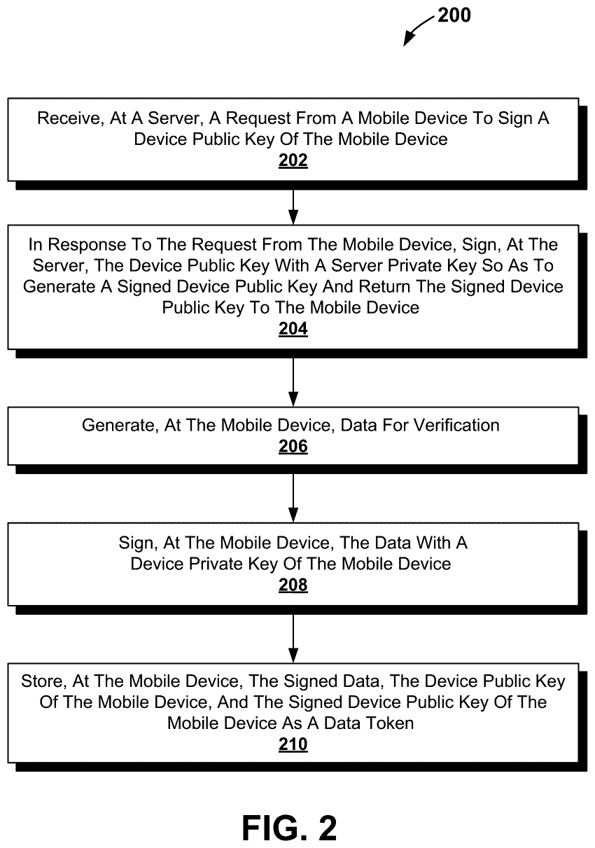

FIG. 2 is a flowchart of an example method 200 of verifying digital content in accordance with one or more embodiments provided herein. In some implementations, one or more process blocks of FIG. 2 may be performed by system 100 of FIGS. 1A and/or 1B.

As shown in FIG. 2, process 200 may include receiving, at a server, a request from a mobile device to sign a device public key of the mobile device (block 202). For example, system 100 may receive, at a server (e.g., server 104), a request from a mobile device (e.g., mobile device 102a) to sign a device public key (e.g., device public key 120) of the mobile device, as described above.

As also shown in FIG. 2, process 200 may include in response to the request from the mobile device, signing, at the server, the device public key with a server private key and returning the signed device public key to the mobile device (block 204). For example, system 100 may in response to the request from the mobile device (e.g., mobile device 102a), sign, at the server (e.g., server 104), the device public key (e.g., device public key 120) with a server private key (e.g., server private key 122) so as to generate a signed device public key (e.g., signed device public key 124) and return the signed device public key to the mobile device, as described above.

As further shown in FIG. 2, process 200 may include generating, at the mobile device, data for verification (block 206). For example, system 100 may generate, at the mobile device (e.g., mobile device 102a), data for verification (e.g., one or more of data 130a-n), as described above.

As also shown in FIG. 2, process 200 may include signing, at the mobile device, the data with the device private key of the mobile device (block 208). For example, system 100 may sign, at the mobile device (e.g., mobile device 102a), the data (e.g., one or more of data 130a-n) with the device private key (e.g., device private key 132) of the mobile device, as described above.

As further shown in FIG. 2, process 200 may include storing, at the mobile device, the signed data, the device public key of the mobile device, and the signed device public key of the mobile device as a data token (block 210). For example, system 100 may store, at the mobile device (e.g., mobile device 102a), the signed data, the device public key (e.g., device public key 120) of the mobile device, and the signed device public key (e.g., signed device public key 124) of the mobile device as a data token, as described above.

Although FIG. 2 shows example blocks of process 200, in some implementations, process 200 may include additional blocks, fewer blocks, different blocks, or differently arranged blocks than those depicted in FIG. 2. Additionally, or alternatively, two or more of the blocks of process 200 may be performed in parallel.

### Examples

In some embodiments, methods and apparatus are provided for cryptographically verifying that digital content was generated on an instance of a specific app running on a device (e.g., verifying that an application, such as verifying app 128, is a valid application that generated data).

In some embodiments, the app may be computer code, the device maybe a smartphone, smartwatch, tablet, smart glasses, a computer or the like, and/or the content to be verified, for example, may comprise a photograph or video taken using a mobile device (e.g., a mobile telephone, a tablet, smart glasses, or the like). In some embodiments the present method and apparatus may be used to verify that content has not been edited or computer generated.

To verify that content was generated via an app instance on a device, in some embodiments the method may comprise a number of the following steps:

Cryptographically verifying that a user attempting to register content is legitimate. In some embodiments, this may involve creating a trusted server which verifies a device's legitimacy (e.g., server 104). In some embodiments, the server may securely provide information that could only have come from the server, allowing others to check that the device is legitimate. In some embodiments, this information may take the form of a cryptographic signing algorithm applied to a unique identifier of the device or user.

Storing the cryptographic verification that a device is legitimate in a secure device hardware location (e.g., a secure memory). This may reduce the possibility that the verification may be leaked and an unverified user may claim verification.

Creating a token for the image that ties it to a verified user of an app instance. In some embodiments, this identifier may be a cryptographic signing algorithm. In some embodiments, the cryptographic signing algorithm could be applied directly to the image (or other content), whereas in other embodiments the cryptographic signing algorithm could be applied to a function of the image, such as a hash for the image (or other content).

To verify that content was edited in a specific way, the method may comprise one or more of the following steps: (1) using any of the embodiments described above to verify an unedited image; and/or (2) if an image is determined to have been edited, cryptographically tying the edited image to the verified unedited image. (In some embodiments, this may involve using cryptographic signing to tie the edited image to the unedited image.)

Cryptographically Verifying that an Editing Software is Legitimate

In some embodiments, cryptographically verifying that an editing software is legitimate may involve creating a trusted server which verifies editing software's legitimacy. In some embodiments, the server may securely provide information which could only have come from the server, allowing others to check that the software is legitimate. In some embodiments, this information may take the form of a cryptographic signing algorithm applied to a unique identifier of the software; or employing the editing software to verify that an image it produces has been edited by the software or by a specific feature of that software. In some embodiments, this verification may be done using cryptographic signing.

Embodiments may allow a user to tie a verified image to a user or device in such a way that verifies ownership. In some embodiments, this may be done using a blockchain and/or using non-fungible tokens.

In some embodiments, quantum-safe cryptographic protocols may be employed.

### Additional Examples

In some embodiments, a digital signing procedure may be employed, with all the standard technical assumptions about non-reversibility. The minimal desired functionality in some embodiments is summarized below, but the technical assumptions are standard in the field of modern cryptography, and details can be found in any standard cryptography textbook. Some embodiments may use RSA digital signing for the digital signing procedure.

Standard digital signing procedures define a pair of cryptographic functions SIGN and VERIFY, and the ability to generate arbitrarily many public key/secret key pairs (pk, sk) such that sk cannot be reverse engineered from pk. Herein these cryptographic public key/secret key pairs are referred to as “key pairs”. Any digital data (i.e. sequence of bits) is referred to as a “message”. In the digital signing procedure, given a message x, embodiments provided herein can generate a signature SIGN (sk, x) such that VERIFY (pk, S, x)=TRUE for message S if and only if S=SIGN (sk, x).

In some embodiments, a standard irreversible hash function may be employed, again with all the standard technical assumptions as are routine in modern cryptography. Let HASH be such a standard irreversible hash function. Some embodiments may use SHA-256 to implement the irreversible hash function. In some embodiments, we may not use the hash function, or equivalently use the identity function as HASH.

As used herein, “providers” refers to the service providers, “app” refers to the software distributed by the providers to the public, “user” refers to a user of the app, “device enclave” refers to hardware that cannot be read by anyone (including the user) and has the capability to compute SIGN (sk, x) for any input x to the hardware, while keeping sk hidden from any person (including the user) and a “capable device” refers to a device that contains a device enclave. Some embodiments may require that app instances are run on one or more capable devices. In other embodiments, app instances can be run on one or more devices that do not include a device enclave.

### App Installation

The providers may generate a key pair (PK, SK) and publish PK (the public key) such that it is readily available to all users. This key pair (PK, SK) is referred to herein as the “provider key pair.” The secret key of the provider key pair is kept secret by the providers. In some embodiments, the providers may periodically rotate/regenerate the provider key pair (PK, SK).

At the moment of app installation, or before signing data (e.g., user content or a hash of user content), a new key pair (pk, sk) unique to this app instance may be generated, hereafter referred to as the “user key pair”. Some embodiments may use the device enclave to generate the user key pair. After the user key pair is generated by the app instance, the app instance may transmit pk to the providers. The providers may reply with an “identity verification token” iv:=SIGN (SK, pk).

In some embodiments, this identity verification token could not have been generated by any party except for the providers. In some embodiments, the secret key sk never leaves the device enclave. In other embodiments (for example, those embodiments in which capable devices are not required), the secret key does not have to be stored in the device enclave.

In some embodiments, it is assumed that this transaction is secure, i.e. that the providers can trust the request from the device is from a legitimate device that is installing the app. This may be done using attestation as described previously.

### Token Generation

Assuming the user generates some local content i (referred to as “content”) within the app instance, the app instance may then compute HASH (i), and may compute SIGN (HASH (i), sk). Some embodiments may use the device enclave to perform this computation. The app instance may then generate a token t:=(HASH (i), SIGN (HASH (i), sk), pk, iv)=: (hi, shi, pk, iv) which may be shared with the app user. If the app user wants to prove that content i was generated within an app instance, they may send both i and t=(hi, shi, pk, iv) to zero, one, or many recipients, each of which is referred to herein as a “receiver.”

Some embodiments may use a camera attached to the device to generate an image as the local content i, which may be computed upon as described above.

### Offline Verification

In order for a receiver to verify the content i using the token t=(hi, shi, pk, iv), the receiver device may check the following three conditions.

HASH(i)=hi

VERIFY(pk,shi,hi)=TRUE

VERIFY(PK,iv,pk)=TRUE

If these three conditions are true, then the content i must have come from a real app instance that was verified at the moment of installation.

In some embodiments, this procedure can be performed offline assuming that the receiver has previously retrieved the public provider key PK, as all the cryptographic functions and relevant keys can be stored locally.

### Example Use Cases

In some embodiments, the methods described may verify that photos, video or other content taken have come from a legitimate instance of the app. In some embodiments, the content i that is verified may be image, video, or audio data collected through the device peripherals (e.g. device camera, device microphone, etc.).

In some embodiments, the methods allow users to cryptographically verify that an image, video, or audio recording, (collectively referred to herein as a non-limiting example of “content”) is taken straight from a smartphone camera or other media capture device (referred to hereafter as a non-limiting example of a “device”) without editing.

Edited content may also be verified such that a specific means of editing can be cryptographically verified.

Some embodiments may ensure that only the user has access to the content that is verified. In some embodiments, an individual or smartphone cannot be identified during the verification process or when proof of verification is given, thus reducing the possibility that content may be selectively verified based on the information it contains.

Some embodiments may enable users or devices to prove ownership of content. This may more easily allow users to monetize their content generated through the app instance. Some embodiments may use non-fungible tokens (NFTs) and blockchain technology in order to prove ownership of content. For example, data and data token pairs may be included as blocks in a blockchain to serve as proof of ownership. With reference to FIG. 1B, in some embodiments, data and token pairs (e.g., data 1 and token 1, data 2 and token 2, etc.) may be included as blocks in a blockchain to serve as proof of ownership.

In general, embodiments provided herein may provide one or more trusted authorities such as a server (e.g., server 104) or secured hardware that contain trusted keys. These trusted keys may sign other keys or data, which may also sign other keys or data, and these signed keys may form a chain or graph of signatures. That is, one or more keys in the chain or graph may sign the data (e.g., user content and/or a hash of user content). This chain or graph of signatures may be used verify the validity/origin of user content and/or other data.

The foregoing description discloses only example embodiments of the invention. Modifications of the above disclosed apparatus and methods which fall within the scope of the invention will be readily apparent to those of ordinary skill in the art. Accordingly, while the present invention has been disclosed in connection with example embodiments thereof, it should be understood that other embodiments may fall within the spirit and scope of the invention, as defined by the following claims.

The foregoing disclosure provides illustration and description but is not intended to be exhaustive or to limit the implementations to the precise form disclosed.

What is claimed is:

1. A system for verifying images, comprising:
a server having a server processor and a server memory, the server processor coupled to the server memory; and
a mobile device having a device processor and a device memory, the device processor coupled to the device memory;
wherein the server includes computer program instructions that, when executed by the server processor, cause the server processor to:
receive a request from the mobile device to sign a device public key of the mobile device; and
in response to the request from the mobile device, sign the device public key with a server private key of the server and return the signed device public key to the mobile device; and
wherein the mobile device includes computer program instructions that, when executed by the device processor, cause the device processor to:
generate data for verification;
sign the data with a device private key of the mobile device; and
store the signed data, the device public key of the mobile device, and the signed device public key of the mobile device as a data token within the device memory.

2. The system of claim 1 wherein the device memory includes computer program instructions that, when executed by the device processor, cause the device processor to:
create the device private key and the device public key;
send a request to the server with the device public key; and
receive the signed device public key from the server.

3. The system of claim 2 wherein the device memory includes computer program instructions that, when executed by the device processor, cause the device processor to:
provide attestation information to the server to verify computer program instructions of the mobile device.

4. The system of claim 3 wherein the server memory includes computer program instructions that, when executed by the server processor, cause the server processor to:
receive attestation information from the mobile device;
determine if computer instructions of the mobile device are valid based on the attestation information;
sign the device public key and return the signed device public key to the mobile device if the server determines the computer instructions of the mobile device are valid based on the attestation information; and
not sign the device public key if the server determines the computer instructions of the mobile device are invalid based on the attestation information.

5. The system of claim 1 wherein the data includes at least one of user content and a hash of user content.

6. The system of claim 1 wherein the mobile device is configured to share verified data with another mobile device without communicating with the server.

7. The system of claim 6 wherein the device memory includes computer program instructions that, when executed by the device processor, cause the device processor to share data and the data token with another mobile device without communicating with the server.

8. The system of claim 1 wherein:
the server memory includes secure memory and standard memory;
the server processor includes a secure processor and a standard processor;
the device memory includes secure memory and standard memory; and
the device processor includes a secure processor and a standard processor;
wherein the server private key is stored in the secure memory of the server; and
wherein the device private key is stored in the secure memory of the mobile device.

9. A method of verifying images, comprising:
receiving, at a server, a request from a mobile device to sign a device public key of the mobile device;
in response to the request from the mobile device, signing, at the server, the device public key with a server private key so as to generate a signed device public key and returning the signed device public key to the mobile device;
generating, at the mobile device, data for verification;
signing, at the mobile device, the data with a device private key of the mobile device; and
storing, at the mobile device, the signed data, the device public key of the mobile device, and the signed device public key of the mobile device as a data token.

10. The method of claim 9 further comprising:
creating, at the mobile device, the device private key and the device public key;
sending, from the mobile device, a request to the server with the device public key; and
receiving, from the server, the signed device public key.

11. The method of claim 10 further comprising providing, from the mobile device to the server, attestation information to verify computer program instructions of the mobile device.

12. The method of claim 10 further comprising:
receiving, at the server, attestation information from the mobile device;
determining, at the server, if computer instructions of the mobile device are valid based on the attestation information;
signing, at the server, the device public key and returning the signed device public key to the mobile device if the server determines the computer instructions of the mobile device are valid based on the attestation information; and
not signing, at the server, the device public key if the server determines the computer instructions of the mobile device are invalid based on the attestation information.

13. The method of claim 9 further comprising employing the mobile device to share verified data with another mobile device without communicating with the server.

14. The method of claim 13 further comprising employing the mobile device to share the data and the data token with another mobile device without communicating with the server.

15. A system for verifying images, comprising:
a server having a server processor and a server memory, the server processor coupled to the server memory; and
an application executable on a mobile device having a device processor and a device memory;
wherein the server includes computer program instructions that, when executed by the server processor, cause the server processor to:
receive a request from the mobile device to sign a device public key of the mobile device; and
in response to the request from the mobile device, sign the device public key with a server private key of the server and return the signed device public key to the mobile device; and
wherein the application executable on the mobile device includes computer program instructions that, when executed by the device processor, cause the device processor to:
generate data for verification;
sign the data with a device private key of the mobile device; and
store the signed data, the device public key of the mobile device, and the signed device public key of the mobile device as a data token within the device memory.

16. The system of claim 15 wherein the device memory includes computer program instructions that, when executed by the device processor, cause the device processor to:
create the device private key and the device public key;
send a request to the server with the device public key; and
receive the signed device public key from the server.

17. The system of claim 16 wherein the device memory includes computer program instructions that, when executed by the device processor, cause the device processor to:
provide attestation information to the server to verify computer program instructions of the mobile device.

18. The system of claim 17 wherein the server memory includes computer program instructions that, when executed by the server processor, cause the server processor to:
receive attestation information from the mobile device;
determine if computer instructions of the mobile device are valid based on the attestation information;
sign the device public key and return the signed device public key to the mobile device if the server determines the computer instructions of the mobile device are valid based on the attestation information; and
not sign the device public key if the server determines the computer instructions of the mobile device are invalid based on the attestation information.

19. The system of claim 15 wherein the data includes at least one of user content and a hash of user content.

20. The system of claim 15 wherein the mobile device is configured to share verified data with another mobile device without communicating with the server.
